(19) United States
(12) Patent Application Publication
(10) Pub. No.: US 2022/0193824 A1
(43) Pub. Date: Jun. 23, 2022

(54) 3D CONNECTOR STRUCTURE, METHOD FOR PRODUCING A 3D CONNECTOR STRUCTURE AND TEMPERATURE SENSOR

(71) Applicant: Heraeus Nexensos GmbH, Kleinosthim (DE)

(72) Inventors: Matthias MUZIOL, Mainhausen (DE); Martin BLEIFUSS, Kahl (DE); Karlheinz WIENAND, Aschaffenburg (DE); Jakob FISCHER, Rossdorf (DE); Yasin KILIC BEYTULLAH, Hanau (DE)

(73) Assignee: Heraeus Nexensos GmbH, Kleinostheim (DE)

(21) Appl. No.: 17/600,748

(22) PCT Filed: Mar. 4, 2020
(86) PCT No.: PCT/EP2020/055701

§ 371 Date: Oct. 1, 2021

(30) Foreign Application Priority Data
Apr. 1, 2019 (EP) 19166472.1

(51) Int. Cl. B23K 26/32; G01K 7/18; B23K 26/22; B23K 26/244

(52) U.S. Cl. CPC B23K 26/32; G01K 7/18; B23K 2101/38; B23K 26/244; B23K 26/22

(57) ABSTRACT

One aspect relates to a 3D connector structure for electrically connecting at least one flat electrode to at least one connection wire. The 3D connector structure has at least two connectors which are spatially separate from one another. The connectors in each case have an electrically conductive material, a first side and a second side. The second side of each connector is connected to an electrical connection element. A spacing of at least 100 μm is constructed between the first side and the second side of each connector.

The invention relates to a 3D connector structure for electrically connecting at least one flat electrode to at least one connection wire. Furthermore, the invention relates to a method for producing a 3D connector structure and a temperature sensor, which has a 3D connector structure.

It is known from the prior art to produce an electrical connection between a connection pad of a platinum-based sensor structure and a connection line by means of known bonding methods, such as thermocompression or ultrasound. A connection of this type is disclosed in DE 26 15 473 A1 for example.

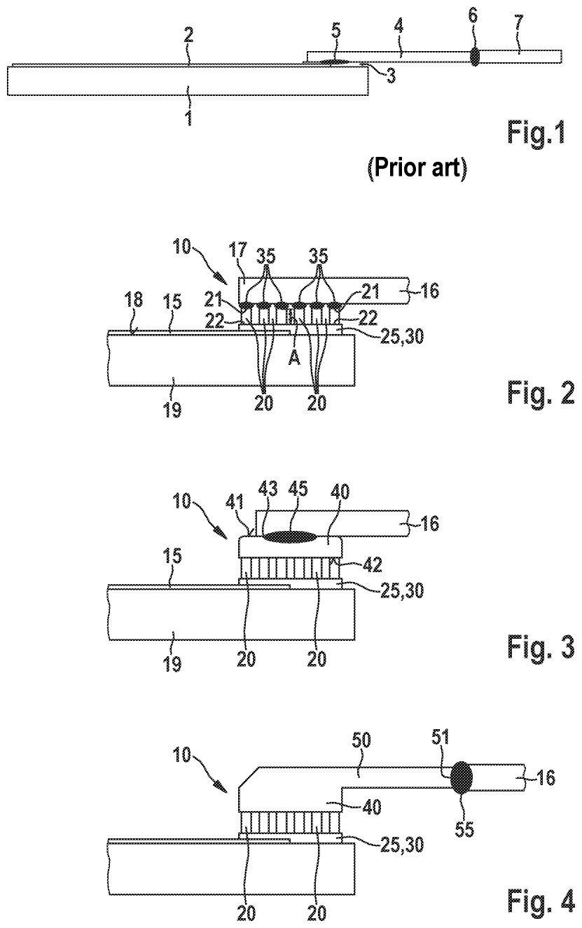

As illustrated schematically in FIG. 1, a platinum thin film structure 2 is applied on a ceramic substrate 1, on the upper side thereof. The platinum thin film structure 2 is meander-shaped and has two electrodes at the ends. The electrodes have perforation holes for example. The electrodes are coated with a screen-printing paste 3 at least in certain sections. In addition to noble metal, the screen-printing paste 3 also contains glass frit, in order to allow a good connection of the paste to the ceramic substrate 1 and the platinum thin film structure 2 exposed through the perforation holes. The electrode pad structured in such a manner may also consist of more than one screen-printed layer.

After the burning in of the screen-printing paste 3, a noble-metal-containing connection wire 4 is welded onto the burned-in screen-printing paste 3. The welding spot 5 is illustrated in this regard. A known welding method in this regard is gap welding. In this case, a dual electrode is pressed onto the connection wire 4 and an electric voltage is applied. The current that flows through the connection wire 4 and the screen-printing paste 3 located therebelow fuses the composite at the contact point between the screen-printing paste 3 or the electrode pad produced and the connection wire 4. A solid metallic joint is created.

Owing to the similarity of the noble metals used in the screen-printing paste 3 and in the connection wire 4, the coefficients of expansion of both components are likewise very similar.

The joint between the electrode pad produced and the connection wire 4 is correspondingly stable, even in the event of strong temperature fluctuations, as prevail for example in the exhaust train of an internal combustion engine.

The connection wire 4 illustrated, which is preferably formed from platinum, may have a wire extension. To this end, a wire extension 7 is attached to the connection wire 4 by means of a further welding spot 6. This wire extension 7 may be manufactured from a nickel alloy for example.

One disadvantage of this known structure of a temperature sensor and the production connected therewith can be seen in particular in the proportion of noble metal material required therefor in the overall structure. The proportion of noble metal in the screen-printing paste 3 and in the connection wire 4 is extremely high. The high costs of the noble metal essentially determine the total costs of a temperature sensor to be produced. It is therefore necessary to search for solutions in order to reduce the material costs for the electrical connection between a flat electrode and a connection wire.

Although solutions are known, according to which a noble-metal connection wire, for example a platinum connection wire, is replaced by a platinum-coated NiCr wire, the production of wires of this type is extremely complex, so that in this regard, no cost saving is achieved with regards to the temperature sensor to be produced.

In light of the aforementioned, it is the object of the present invention to specify a connector structure for electrically connecting at least one flat electrode to at least one connection wire, which on the one hand fulfils the requirements in high-temperature environments, for example an environment of an exhaust train, and on the other hand is improved with regards to the noble metal proportions. The noble-metal proportions should be reduced drastically in connection with a connector structure according to the invention.

Further, it is an object of the present invention to specify a developed method for producing a 3D connector structure for electrically connecting at least one flat electrode to at least one connection wire. Additionally, it is an object of the present invention to specify a developed temperature sensor.

According to the invention, this object is achieved with regards to the 3D connector structure by the subject matter of claim 1, with regards to the method for producing a 3D connector structure by the subject matter of patent claim 12 and with regards to a temperature sensor by the subject matter of patent claim 17.

The invention is based on the idea of specifying a 3D connector structure for electrically connecting at least one flat electrode to at least one connection wire, wherein according to the invention, the 3D connector structure has at least two connectors which are spatially separate from one another, wherein the connectors in each case have an electrically conductive material, a first side and a second side, wherein the second side of each connector is or can be connected to an electronic connection element, wherein a spacing of at least 100 μm, in particular of at least 200 μm, in particular of at least 300 μm, is constructed between the first side and the second side of each connector.

A connector structure which is constructed three-dimensionally is to be considered as a 3D connector structure in particular. The connector structure is therefore not only of flat construction, as this is to be understood in the sense of a flat strip or a flat sheet. Rather, the 3D connector structure is correspondingly dimensioned in all three directions, i.e. both with regards to the length and width, as well as with regards to the height.

A connector structure which has a plurality of connectors is to be understood as a 3D or three-dimensional connector structure in particular. The connectors may also be termed feet or contacting feet. The 3D connector structure therefore comprises at least two connectors which are spatially separate from one another. Each connector has a first side and a second side. These two sides are preferably the sides of the connector which are farthest from one another.

The first side of a connector may be termed the upper side. The second side of a connector may be termed the lower side of a connector. The orientations with regards to “above” and “below” can be seen in the contacted state in particular. In this case, an orientation is to be understood of the type according to which a substrate, which has the at least one flat electrode which is to be contacted, is placed horizontally on a set-down surface.

A spacing of at least 100 μm, in particular of at least 200 μm, in particular of at least 300 μm, is constructed between the first side and the second side of each connector. The spacing between the two sides of each connector is produced by means of material deposition between the two sides or by means of material filling between the two sides. The described spacing should in particular not be understood as a spacing which corresponds to an air gap between the two sides.

At least one connector may be constructed as a web and/or pillar and/or lamina. Preferably, all connectors are constructed in the same way. Furthermore, it is possible that the connectors are constructed differently and a plurality of designs of connectors, i.e. different connector configurations, are constructed in a 3D connector structure according to the invention.

The electrical connection element may be the flat electrode and/or a connection pad and/or a section of the flat electrode. The connection pad is preferably a connection pad of a type which is formed from a sintering paste. Preferably, the connection pad is produced from a sintering paste by means of a screen printing method. In addition to noble metal, the screen-printing paste may also contain glass frit. In a possible embodiment of the invention, the 3D connector structure may comprise the electrical connection element. In other words, the electrical connection element, particularly the connection pad, may be constructed as a part of the 3D connector structure.

In an embodiment of the invention, it is possible that the first sides of the connectors form a common plane and are connected to at least one bridge, which consists of electrically conductive material, and/or the connection wire.

In other words, it is possible that the first sides of the connectors are connected directly to the connection wire to be connected. Alternatively, it is possible that the first sides of the connectors are connected to at least one bridge. The construction of a bridge has the advantage that the 3D connector structure can be handled, particularly transported, and produced particularly easily as a separate half component.

In the invention, the at least two connectors are constructed as resilient compensating elements. The resilient compensating elements act between a connection wire and the flat electrode to be connected electrically. This makes it possible that on the one hand a flexibility is ensured between the at least one connection wire with the at least one flat electrode and on the other hand a stable mechanical joint is created.

With the aid of the 3D connector structure according to the invention, it is possible to produce a relatively large and cohesive contact region between a connection wire and a flat electrode. In particular, the connection surface provided by means of a connection pad can be utilized maximally owing to the 3D connector structure according to the invention. It would be possible to minimize the size of the connection pad in relation to hitherto known sizes of connection pads.

The electrically conductive material of the bridge is in particular a high-temperature alloy, particularly alloy 601 (2.4851) and/or alloy 602 (2.4633) and/or AluChrom (1.4767).

In a preferred embodiment of the invention, it is possible that the connectors and the bridge are constructed in one piece, i.e. in particular in one piece and/or monolithically. It is possible that the connectors and the bridge are produced in a single production step.

Owing to the construction of a plurality of, in particular elongated, connectors and/or the construction of a bridge, with the aid of the 3D connector structure according to the invention, the overall structure of a component to be produced, particularly a temperature sensor, is protected during the connection of the connection wire to the component. A substrate and an electrode structure located thereon is protected from a temperature effect (welding temperature) arising during connection, as the connectors and/or the bridge form a corresponding spacing from the substrate/the electrode structure.

The bridge of the 3D connector structure may have a contacting region for connecting to the connection wire, which is preferably constructed as a receptacle for fixing the at least one connection wire. The receptacle is preferably constructed as a channel and/or a bush and/or a groove. The at least one connection wire can be inserted into a receptacle of this type. A materially connected and/or positive connection may additionally be provided between the bridge and the connection wire.

In a further embodiment of the invention, it is possible that the bridge has an electrically conductive extension, which protrudes beyond the region of the connectors and has a section for contacting with the connection wire. The extension preferably comprises, particularly consists of, the same electrically conductive material as the bridge. The extension may be produced in one method step together with the bridge by means of additive manufacturing. With the aid of an extension of this type, the contact point of the at least one connection wire can be placed into a region outside of the electrical connection element, particularly outside of the connection pad. This facilitates a later contacting of the component.

On the basis of the construction according to the invention of a 3D connector structure with a plurality of connectors which are spatially separate from one another, the connectors with a flat electrode and/or a connection pad are connected to one another only in a very small region, i.e. on a relatively small surface. For this purpose, each connector has on the second side, in other words on the lower side, a contact surface for contacting with the at least one electrical connection element, wherein each contact surface is 100 μm² to 0.5 mm², preferably 300 μm² to 0.1 mm², particularly 1,000 μm² bis 50,000 μm².

The smaller the contact region, i.e. the contact surface of the second sides, of each connector is, the smaller is the likelihood that a break in the contact region between the second side of the connector and the electrical connection element occurs in the event of temperature changes. This is true in particular in cases when the materials for the electrical connection element and the connectors have coefficients of thermal expansion that differ from one another considerably.

The electrically conductive material of at least one connector preferably has a high-temperature alloy. Particularly preferably, the electrically conductive material contains alloy 601 (2.4851) and/or alloy 602 (2.4633) and/or AluChrom (1.4767).

The at least one flat electrode and/or the connection pad preferably contains noble metal, particularly platinum. The noble-metal proportion of the flat electrode is preferably at least 20% by weight, particularly at least 40% by weight, particularly at least 70% by weight.

In a further embodiment of the invention, the at least one connection wire comprises a high temperature alloy, particularly alloy 601 (2.4851) and/or alloy 602 (2.4633) and/or AluChrom (1.4767).

The materials used for producing at least one connector and/or at least one bridge are preferably a metal powder.

Suitable metal powders are for example powders formed from a high-temperature alloy, as are specified in the following table:

TABLE 1

| | | max. Temp. | Resistance | Expansion | |
|---|---|---|---|---|---|
| Material | | acc. Key to | 20° C. | 100° C. | |
| number | Name | Steel | Ω mm²/m | 10 E −6/K | Alloy |
| 1.4767 | Cat. sheet | 1200 | | | Cr21 Al5 Si1 Mn1 |
| | AluChrom | | | | |
| 1.4765 | | 1300 | | | Cr24 Al5 Si1 |
| | Kanthal D | | 1 | | Fe71 Cr22 Al5 Mn1 |
| | | | | | Si1 |
| 2.4869 | NiCr 8020 | 1200 | 1.12 | 15 at 400° C. | Ni75 Cr20 Si1 Mn1 |
| | | | | | Fe1 |
| 1.4571 | V4A | | 0.75 | 17 | Ni12Cr17Si1 Mn2Mo2 |
| 1.4841 | SS310 | 1150 | 0.9 | 17 at 400° C. | Cr25 Ni20 Si2 Mn2 |
| 1.4845 | TP 310 S | 1050 | 0.85 | 17 at 400° C. | Ni20Cr25Mn2 |
| 2.4816 | Inconel 600 | 1150 | 0.98 | 13 | Ni72 Cr16 Fe8 Mn1 |
| 2.4851 | alloy 601H | 1200 | 1.19 | 14 | Ni60 Cr23 Fe18 Al2 |
| | Nicrofer 6023 H | | | | Mn1 |
| 2.4633 | alloy 602 CA | 1200 | 1.19 | 12 | Ni62 Cr25 Fe10 Al2 |
| | Nicrofer 6025 HT | | | | |
| 2.4833 | alloy 602 MCA | 1200 | 1.25 | 14 | Ni62 Cr25 Fe10 Al2 |
| | Nicrofer 6025 HT | | | | |
| | SO2 | | | | |
| 2.4663 | Inconel 617 | | | | Ni54 Cr22 Co 13 Mo9 |
| | Nicrofer 5520 Co | | | | Al1 |
| 2.4951 | Nimonic | 1200 | | | Ni72 Cr20 Fe5 Si1 |
| | | | | | Mn1 |
| 2.4733 | Haynes230 | | | | Ni57 Cr22 W14 Co5 |
| | | | | | Fe3 Mo2 |
| | Nicrosil | | | | Ni84 Cr14 Si1.5 |

The diameter of the connection wire is preferably 100 μm to 800 μm, particularly 200 μm to 500 μm, particularly 250 μm to 350 μm.

It is possible owing to the construction according to the invention of the 3D connector structure, that it is possible to dispense with noble-metal-containing connection wires completely. This is also true in connection with the material of the 3D connector structure according to the invention. It is also possible in this context to dispense with noble-metal materials completely.

A further aspect of the invention relates to a method for producing a 3D connector structure for electrically connecting at least one flat electrode to at least one connection wire.

The method according to the invention is suitable in particular for producing a 3D connector structure according to the invention.

According to the invention, it is provided that at least two connectors which are spatially separate from one another are produced from an electrically conductive material by means of an additive manufacturing method, wherein the connectors have a first side and a second side in each case and a spacing of at least 100 μm, in particular of at least 200 μm, in particular of at least 300 μm, is produced between the first side and the second side of each connector by means of material deposition.

It is possible that the connectors are applied on an electrical connection element during the method for producing a 3D connector structure.

The spacing constructed according to the invention between the two sides of a connector in each case is consequently produced by material deposition. The spacing between the two sides therefore corresponds to the material thickness of the connector, which is constructed between the two sides of the connector.

In a particularly preferred embodiment of the invention, the additive manufacturing method is a 3D printing method. The 3D printing method should preferably be an additive manufacturing method of a type in which a material is deposited in layers as powder or as a solution and, after the deposition, is bonded locally using high-energy radiation at the locations at which the component to be manufactured should have correspondingly hardened material available. The bonding of the powder or the solution can take place by means of a local fusing, sintering or cross-linking process. The high-energy radiation can be applied for example by means of a laser, an electron beam or by means of focused UV radiation.

On the basis of a production method of this type, it is possible to use different material combinations with regards to the materials for the at least one connection wire and for the flat electrode, particularly for the connection pad.

On the basis of the method according to the invention, it is for example possible to use high-temperature alloys for producing the 3D connector structure, which are far less expensive than noble metals and furthermore have better properties with regards to hardness, low thermal conductivity and bondability.

In a further embodiment of the invention, a bridge made from electrically conductive material can be applied onto the first sides of the connectors. This application or construction of the bridge can in turn take place by means of an additive manufacturing method. In particular, a contacting region, which is used for connecting to at least one connection wire, is constructed on the bridge. The contacting region may in turn have a receptacle, which is preferably constructed as a bush and/or a channel and/or a groove. The production of a receptacle of this type is simplified owing to the additive manufacturing method according to the invention.

The at least one connection wire is connected to the first sides of the connectors and/or to the bridge. Preferably, this connection takes place by means of a laser welding method.

Preferably, the connectors are applied directly on an electrical connection element, particularly on a connection pad. In the case of the application according to the invention of an additive manufacturing method, the manufacturing temperature, particularly a laser power, is to be set in such a manner that on the one hand, a good bond of the powder particles and a good connection of the connectors to the connection pad is produced. However, the manufacturing temperature, particularly the laser power, must be set in such a manner that the material of the electrical connection element, particularly the sintering paste material of the connection pad, is not damaged.

The powders used in the production of the connectors and/or the bridge preferably have a particle size distribution of up to 20 μm. A laser with an energy of for example 100 watts is preferably used for sintering the powdered material. The laser focus is preferably smaller than 20 μm.

The connectors and/or the bridge are/is produced from a powder which contains a high-temperature alloy material. In particular, powders such as alloy 601 (2.4851) and/or alloy 602 (2.4633) and/or AluChrom (1.4767) are suitable. In this context, reference is furthermore made again to the materials specified in Table 1.

A further aspect of the invention relates to a temperature sensor with a 3D connector structure. The 3D connector structure is a 3D connector structure according to the invention and/or a 3D connector structure produced according to the invention.

Similar advantages result, as are already specified in connection with the method according to the invention for producing a 3D connector structure and/or with the 3D connector structure according to the invention.

On the basis of the 3D connector structure according to the invention for electrically connecting at least one flat electrode to at least one connection wire, a solution is provided, using which it is possible to permanently connect materials with different coefficients of expansion to one another. On the basis of the construction of a plurality of, particularly resiliently configured, connectors, which are arranged spatially separate from one another, it is possible to permanently connect electrical connection elements, which are for example manufactured from platinum and/or comprise platinum, to connection wires, which are for example produced from nickel and/or high-grade steel.

The preferably resilient property of the connectors makes it possible to compensate the differences in expansion behaviour of the electronic connection element and the connection wire, even in the case of high temperatures and rapid temperature changes.

The invention is described in more detail in the following on the basis of exemplary embodiments, with reference to the attached drawings.

In the figures:

FIG. 2 shows a 3D connector structure in the already-contacted state according to a first embodiment according to the invention;

FIG. 3 shows a 3D connector structure in the already-contacted state according to a second embodiment of the invention according to the invention;

FIG. 4 shows a 3D connector structure in the already-contacted state according to a third embodiment of the invention;

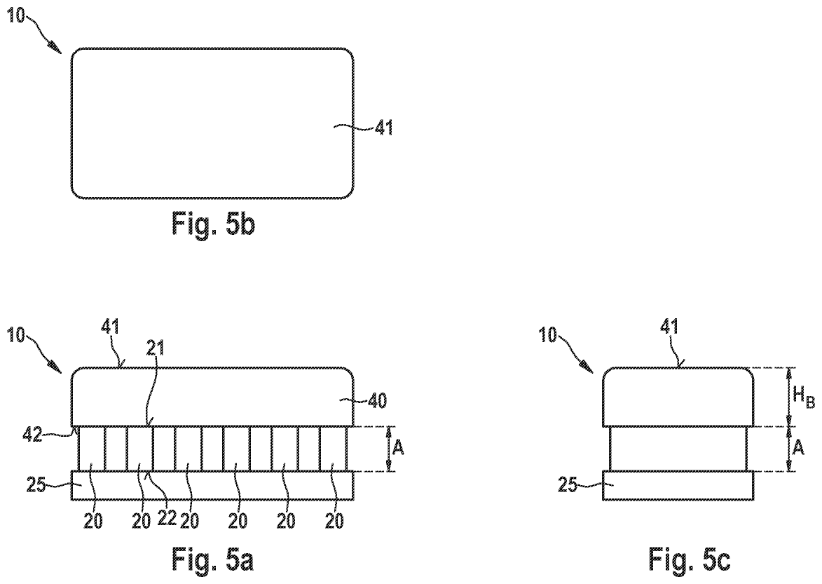

FIGS. 5a-5c show a detail illustration of a 3D connector structure according to the invention in various views;

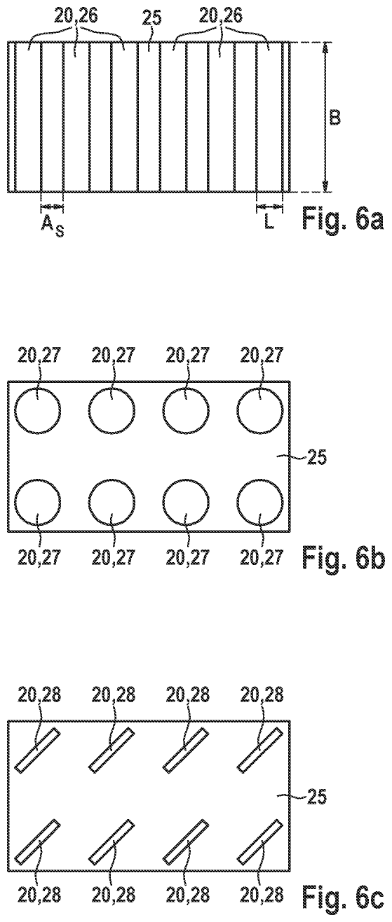

FIGS. 6a-6c show various embodiments with regards to the construction of the connectors of 3D connector structures according to the invention;

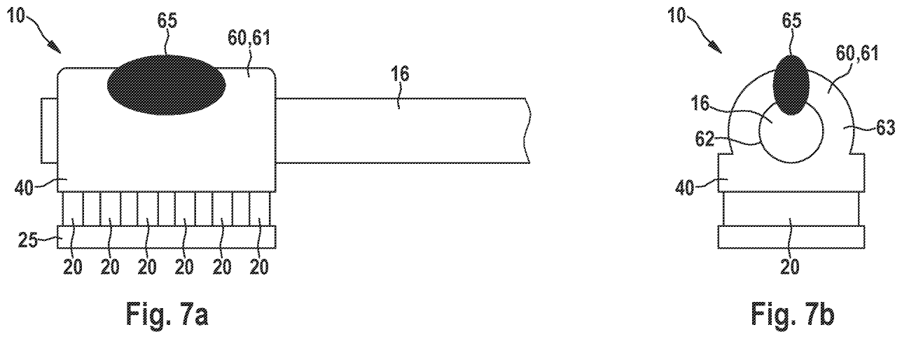

FIGS. 7a and 7b show a first possible embodiment of a receptacle of a bridge of a 3D connector structure according to the invention;

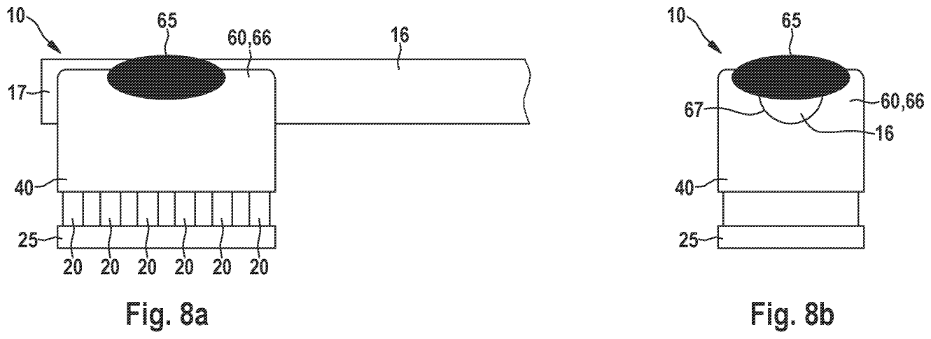

FIGS. 8a and 8b show a second embodiment of a receptacle of a bridge of a 3D connector structure according to the invention; and

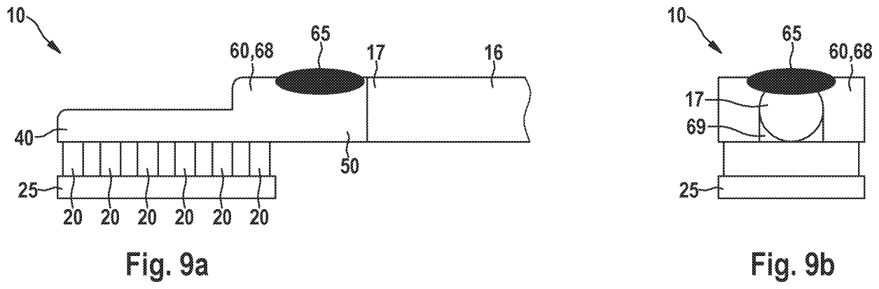

FIGS. 9a and 9b show a third embodiment of a receptacle of a bridge of a 3D connector structure according to the invention.

The same reference numerals are used in the following for the same components and components with the same action.

A first possible embodiment with regards to a 3D connector structure 10 according to the invention is illustrated in FIG. 2. The 3D connector structure 10 is used for electrically connecting a flat electrode 15 to a connection wire 16. The flat electrode 15 is in this case particularly constructed as a platinum thin film structure, which is meander-shaped. The platinum thin film structure or the flat electrode 15 is located on an upper side 18 of a substrate 19, particularly a ceramic substrate.

A connection pad 25 is constructed on the flat electrode 15. In the example illustrated, the connection pad 25 is used as an electrical connection element 30.

The 3D connector structure 10 comprises at least two connectors 20. In the exemplary embodiment illustrated, the 3D connector structure 10 comprises six connectors 20. These connectors 20 are spatially separate from one another and are produced from an electrically conductive material. All connectors 20 have a first side 21 and a second side 22. The first side 21 is the upper side in other words. The second side 22 is the lower side of each connector 20 in other words. According to the exemplary embodiment of FIG. 2, the first sides 21 of the connectors 20 are connected to the connection wire 16. By contrast, the second sides 22 are connected to the connection pad 25.

A spacing A of at least 100 μm, in particular of at least 200 μm, in particular of at least 300 μm, is constructed between the first side 21 and the second side 22 of each connector 20. In other words, the spacing A corresponds in the connectors 20 illustrated to the height of the connectors 20. The connectors 20 are connected at their first sides 21 to the connection wire 16. Here, the connectors 20 are individually connected to the connection wire 16 by means of fusion welding, particularly by means of laser welding. The welding spots 35 are illustrated in this regard.

The flat electrode 15 contains noble metal, particularly platinum, wherein the proportion of noble metal of the flat electrode 15 is greater than 20% by weight. The connection pad 25 contains noble metal, particularly platinum, wherein the proportion of noble metal of the connection pad 25 is greater than 20% by weight. In the example illustrated, the connection pad 25 has an area of 1.0 mm×0.5 mm.

The connection wire 16 in turn contains a high-temperature alloy. Furthermore, it is possible that the connection wire 16 consists of nickel or high-grade steel and has a diameter of 100 μm to 800 μm, typically of 300 μm.

In the example illustrated, the connectors 20 are built directly on the connection pad 25 by means of an additive manufacturing method, particularly by means of 3D printing. A powder made from a metallic high-temperature alloy is used as powder in the additive manufacturing or in the 3D printing. In particular, a powder made from alloy 601 (2.4851) and/or alloy 602 (2.4633) and/or AluChrom (1.4767) is used. The powders preferably have a particle size distribution of up to 20 μm. A laser with an energy of for example 100 watts is preferably used for sintering the powdered material, wherein the laser focus is smaller than 20 μm.

In the exemplary embodiment illustrated, the connectors 20 are constructed as webs. The height of the connectors 20 in the present example is 500 μm. The connectors additionally preferably have a width of 500 μm and a length of 40 μm. The width and length in turn form the surface of the first side 21 and/or second side 22 in each case. Preferably, the connectors 20 have a spacing from one another of 20 μm.

The connection wire 16 is arranged perpendicular to the sides forming the heights of the connectors 20 and contacts the first sides 21 of the connectors 20 approximately in the middle.

The connection pad 25 is preferably formed from a platinum-containing sintering paste.

An alternative embodiment of a 3D connector structure 10 is illustrated in FIG. 3. The 3D connector structure 10 has a bridge 40. The first sides 21 of the connectors 20 here form a common plane E and are connected to this bridge 40 at this common plane E. The bridge 40 is likewise produced from electrically conductive material. Preferably, the bridge 40 is produced from the same material as the connectors 20.

In a particularly preferred embodiment of the invention, the connectors 20 and the bridge 40 are constructed in one piece. The bridge 40 has a first side 41 and a second side 42. The connectors 20 are attached on the first side 21 of the connectors on the second side 42 of the bridge 40 or connected on this second side 42 to the bridge 40. By contrast, the connection wire 16 is attached on the first side 41, which corresponds to an upper side of a bridge 40. In the exemplary embodiment presented, the bridge 40 is connected to the connection wire 16 on the first side 41 by means of a welding spot 45.

In a particularly preferred embodiment of the invention, the bridge 40 together with the connectors 20 are produced in one process step by means of an additive manufacturing method.

In the exemplary embodiment illustrated, the bridge 40 covers the connectors 20, wherein the bridge has a height of approx. 300 μm. The connection of the connection wire 16 by means of the welding spot 45 preferably takes place by means of a laser welding method. To this end, the bridge 40 has a contacting region 43.

The remaining elements and components correspond to the exemplary embodiment according to FIG. 2, so these are not covered again separately.

A further embodiment of a 3D connector structure 10, which likewise has a bridge 40, is illustrated in FIG. 4. The bridge 40 and the connectors 20 are in turn manufactured from the same material. The bridge 40 has an electrically conductive extension 50, which protrudes beyond the region of the connectors 20. The extension 50 in addition has a section 51 for contacting with the connection wire 16. In FIG. 4, the section 51 for contacting with the connection wire 16 is constructed as an end side. At this end side or the section 51, the extension 50 and thus the 3D connector structure 10 is connected to the connection wire 16 by means of a welding spot 55. Also in this context, the connection may take place by means of a laser welding method.

The extension 50 is used in particular to construct the connection of the 3D connector structure 10 to the connection wire 16 in a region outside, i.e. not in direct vertical extension of the connection pad 25. The extension 50 is preferably produced in one process step together with the bridge 40 and preferably in one process step together with the connectors 20. This facilitates the later contacting in connection with the substrate 19.

A possible 3D connector structure 10 is illustrated enlarged in FIGS. 5a to 5c. In this case, FIG. 5a shows a side view of the 3D connector structure 10 according to the invention. A plan view is illustrated in FIG. 5b. FIG. 5c is in turn a rotated side view of FIG. 5a.

It can be seen that the 3D connector structure 10 has six connectors 20 with first sides 21 and second sides 22 in each case. The first sides 21 of the connectors 20 are connected to a second side 42 of a bridge 40. By contrast, the second sides 22 of the connectors 20 are in turn connected to the connection pad 25. As FIG. 5b makes clear, the bridge 40 is constructed in a rectangular manner on the first side 41.

This also relates to the extent with regards to the height H_{B} of the bridge. The height H_{B} of the bridge corresponds approximately to the height of the connector 20 and thus to the spacing A between the first side 21 and the second side 22 of the connector 20.

Various embodiments of the connectors 20 are illustrated in a plan view in FIGS. 6a-6c. Accordingly, the base of the connectors 20 is illustrated. In this case, the base may correspond to the shape of the first side 21 and/or the second side 22 of the connector 20. In FIG. 6a, the connectors 20 are illustrated as webs 26 in particular. The webs 26 are in particular constructed in such a manner that the widths B of the webs 26 have a larger dimension than the lengths L of the webs 26. The widths B of the webs 26 further correspond to the width of the connection pad 25. The lengths L of the webs 26 correspond approximately to the spacing A_{S} between the webs 26. The spacing A_{S} may also be smaller or larger than the length L of the webs 26.

In FIG. 6b, connectors 20 are illustrated, which are constructed as pillars 27. The pillars 27 have a round cross section in each case in this exemplary embodiment. It is also possible that the pillars 27 have a square cross section. In the exemplary embodiment illustrated, the 3D connector structure 10 has eight connectors 20 in the form of pillars 27.

In FIG. 6c, a further embodiment is illustrated with regards to possible connectors 20. The connectors 20 are constructed as laminae 28. These laminae 28 are arranged obliquely in relation to the connection pad 25. Eight connectors 20 are constructed in the form of laminae 28. The material thickness or material gauge of the connectors 20, 26, 27 and 28 is preferably 100 μm.

The cross section of the connectors 20, which is orientated parallel to the flat electrode or to the connection pad 25 in each case, does not have to be constant. The cross section may change starting from the first side 21 to the second side 22. Both a tapering and a widening of the cross-sectional area is possible. An average cross-sectional area of the connector parallel to the flat electrode or to the connection pad 25 is to be understood to mean the arithmetic mean of all cross-sectional areas, which are arranged equidistantly from the second side to the first side of the respective connector 20.

Different embodiments and views with regards to the configuration of bridges 40 and the associated receptacles 60 are illustrated in FIGS. 7a-9b.

In the embodiment according to FIGS. 7a and 7b, wherein 7b illustrates a side view of FIG. 7a, the bridge 40 has a receptacle 60 in the form of a bush 61. The bush 61 has an internal diameter of such a type that the connection wire 16 can be introduced into the bush 61. The cross section of the recess 62 of the bush 61 may be constructed in a circular manner in this case, so that a generally circular wire, namely a connection wire 16, can be introduced into the bush 61, i.e. into the recess 62. The connection wire 16 is welded to the receptacle 60/61 through the bush 61, i.e. through the wall 63. A welding spot 65 is in turn formed. The welding of the connection wire 16 to the bridge 40 is therefore simplified. In addition, the mechanical stability of the welding spot 65 or the weld seam is increased.

The bridge 40 according to the exemplary embodiments of FIGS. 8a and 8b likewise has a receptacle 60. In this case, the receptacle 60 is configured as a channel 66. The connection wire 16 is laid into the channel 66. The channel 66 has a U-shaped or half-round recess 67. After the connection wire 16 is introduced or laid into the channel 66, connection of the connection wire 16 to the bridge 40 can then in turn take place on the basis of the receptacle 60. A weld seam or a welding spot 65 is formed. The welding spot 65 covers the connection wire 16 and therefore the channel 66.

A receptacle 60 of a bridge 40 is in turn illustrated in FIGS. 9a and 9b. In the example illustrated, the receptacle 60 is constructed in the region of an extension 50. The receptacle 60 is configured as a groove 68. The recess 69 of the receptacle 60/68 has a square or rectangular cross section. The connection wire 16 can in turn be laid into the groove 68. In particular, one end 17 of the connection wire 16 is laid into the groove 68. In this configuration, the connection of the connection wire 16 to the bridge 40 or to the receptacle 60/68 can subsequently take place. Also in this regard, a weld seam/a welding spot 65 is formed for fixing the connection wire.

The groove 68 or the recess 69 can furthermore be configured in such a manner that a mechanical clamping of the connection wire 16 or the end 17 of the connection wire 16 to the bridge 40 takes place.

In a preferred embodiment of the invention, the temperature sensor according to the invention is used in an exhaust train of an internal combustion engine.

The details illustrated in FIGS. 2-9b with regards to a 3D connector structure 10 according to the invention can be realized in all possible combinations with one another.

### REFERENCE LIST

1 Ceramic substrate (prior art)
2 Platinum thin film structure (prior art)
3 Screen-printing paste (prior art)
4 Connection wire (prior art)
5, 6 Welding spot (prior art)
7 Wire extension (prior art)
10 3D connector structure
15 Flat electrode
16 Connection wire
17 Connection wire end
18 Substrate upper side
19 Substrate
20 Connector
21 Connector first side
22 Connector second side
25 Connection pad
26 Web
27 Pillar
28 Lamina
30 Electrical connection element
35 Welding spot
50 Bridge
41 Bridge first side
42 Bridge second side
43 Contacting region of the bridge
45 Welding spot
50 Extension
51 Section
55 Welding spot
60 Receptacle
61 Bush
62 Recess
63 Wall
65 Welding spot
66 Channel
67 Recess channel
68 Groove
69 Recess groove
A Spacing first side to second side
A_{S} Spacing between webs
E Common plane
H_{B} Bridge height
B Web width
L Web length

1-17. (canceled)

18. A 3D connector structure for electrically connecting at least one flat electrode to at least one connection wire, the 3D connector structure comprising:
at least two connectors that are spatially separate from one another;
wherein the connectors in each case have an electrically conductive material, a first side and a second side;
wherein the second side of each connector is connected to an electrical connection element; and
wherein a spacing of at least 100 μm is constructed between the first side and the second side of each connector.

19. The 3D connector structure according to claim 18, wherein a spacing of at least 300 μm is constructed between the first side and the second side of each connector.

20. The 3D connector structure according to claim 18, wherein at least one connector is configured as a web, a pillar or a lamina.

21. The 3D connector structure according to claim 18, wherein the electrical connection element is the flat electrode or a connection pad, formed from a sintering paste.

22. The 3D connector structure according to claim 18, wherein the first sides of the connectors form a common plane and are connected to at least one bridge, which consists of electrically conductive material or the connection wire.

23. The 3D connector structure according to claim 22, wherein the connectors and the at least one bridge are constructed in one piece.

24. The 3D connector structure according to claim 22, wherein the at least one bridge for connecting to the connection wire has a contacting region, which is configured as a receptacle for fixing the connection wire, and wherein the receptacle is constructed as a channel, a bush or a groove.

25. The 3D connector structure according to claim 22, wherein the at least one bridge has an electrically conductive extension, which protrudes beyond the region of the connectors and has a section for contacting with the connection wire.

26. The 3D connector structure according to claim 18, wherein each connector has a contact surface on the second side for contacting with the at least one electrical connection element, wherein each contact surface is 100 μm² to 0.5 mm².

27. The 3D connector structure according to claim 18, wherein each connector has a contact surface on the second side for contacting with the at least one electrical connection element, wherein each contact surface is 1,000 μm² to 50,000 μm².

28. The 3D connector structure according to claim 18, wherein the electrically conductive material of at least one connector is a high-temperature alloy, an alloy 601 (2.4851), alloy 602 (2.4633) or AluChrom (1.4767).

29. The 3D connector structure according to claim 18, wherein the at least one flat electrode or the connection pad contains platinum, wherein the platinum proportion of the flat electrode is at least 20% by weight.

30. The 3D connector structure according to claim 18, wherein the at least one flat electrode or the connection pad contains platinum, wherein the platinum proportion of the flat electrode is at least 70% by weight.

31. The 3D connector structure according to claim 18, wherein the at least one connection wire comprises at least one of a high-temperature alloy, alloy 601 (2.4851), alloy 602 (2.4633), and AluChrom (1.4767), wherein the diameter of the connection wire is 100 μm to 800 μm.

32. A method for producing the 3D connector structure according to claim 18, comprising:
producing at least two connectors, which are spatially separate from one another, from an electrically conductive material using an additive manufacturing method, wherein the connectors have a first side and a second side in each case; and
producing a spacing of at least 100 μm between the first side and the second side of each connector using material deposition.

33. The method according to claim 32, further comprising applying the connectors on an electrical connection element.

34. The method according to claim 32 further comprising applying a bridge made from electrically conductive material onto the first sides of the connectors using an additive manufacturing method, wherein a contacting region is constructed, which is used for connecting to the connection wire.

35. The method according to claim 32, further comprising connecting the connection wire to the first sides of the connectors or to the bridge using laser welding.

36. The method according to claim 34, further comprising producing the connectors or the bridge from a powder which contains a high-temperature alloy material, alloy 601 (2.4851), alloy 602 (2.4633), or AluChrom (1.4767).

37. A temperature sensor having a 3D connector structure according to claim 18.
